(19) United States
(12) Patent Application Publication
(10) Pub. No.: US 2026/0148132 A1
(43) Pub. Date: May 28, 2026

(54) REFINEMENT OF DATA DRIVEN DRIVING MODELS

(71) Applicant: QUALCOMM Incorporated, San Diego, CA (US)

(72) Inventors: Richard Stephen SHAFFER, Philadelphia, PA (US); Paul Daniel MARTIN, Devon, PA (US); Vinay Kumar SENTHIL KUMAR, Philadelphia, PA (US)

(21) Appl. No.: 18/963,362

(22) Filed: Nov. 27, 2024

(51) Int. Cl. G06N 20/00; B60W 60/00

(52) U.S. Cl. CPC G06N 20/00; B60W 60/001

(57) ABSTRACT

Systems and techniques are described herein for refining driving models. For example, a computing device can obtain a machine learning model trained using a set of driving training data, process the set of driving training data to modify a first subset of driving training data from the set of driving training data, the first subset of driving training data associated with a first driving condition; and fine-tune a first instance of the machine learning model using the first modified subset of driving training data.

### FIELD

The present disclosure generally relates to training machine learning models. For example, aspects of the present disclosure relate to systems and techniques for refinement of data driven driving models (e.g., machine learning models for operating autonomous or semi-autonomous vehicles).

### BACKGROUND

Autonomous and semi-autonomous vehicles often include multiple sensors to gather information about the environment which processing systems use to perform various functions such as motion planning, collision avoidance, etc. The unpredictability of other vehicles, pedestrians, and obstacles complicates decision-making processes of autonomous vehicles. For example, autonomous vehicles must anticipate the actions taken by other drivers. The manner in which an autonomous vehicle performs actions affects passenger satisfaction and confidence in the autonomous vehicle. For example, how fast the autonomous vehicle brakes in traffic, how often the autonomous vehicle merges between lanes, how fast the autonomous vehicle accelerates, etc. can affect passenger confidence in the autonomous vehicle. An action performed by an autonomous vehicle can be safe yet still be undesirable for a passenger because the action is not typical of actions performed by a human driver. Further, not every vehicle should be operated in the same manner. For example, vehicles that are heavier oftentimes may need to brake earlier and harder than lighter vehicles.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for refining driving models is provided. The apparatus can include at least one memory and at least one processor coupled to the at least one memory and configured to: obtain a machine learning model trained using a set of driving training data; process the set of driving training data to modify a first subset of driving training data from the set of driving training data, the first subset of driving training data associated with a first driving condition; and fine-tune a first instance of the machine learning model using the first modified subset of driving training data.

In some aspects, a method for refining driving models is provided. The method can include obtaining a machine learning model trained using a set of driving training data; processing the set of driving training data to modify a first subset of driving training data from the set of driving training data, the first subset of driving training data associated with a first driving condition; and fine-tuning a first instance of the machine learning model using the first modified subset of driving training data.

In some aspects, a non-transitory computer-readable medium is provided having stored thereon instructions that, when executed by at least one processor, cause the at least one processor to: obtain a machine learning model trained using a set of driving training data; process the set of driving training data to modify a first subset of driving training data from the set of driving training data, the first subset of driving training data associated with a first driving condition; and fine-tune a first instance of the machine learning model using the first modified subset of driving training data.

In some aspects, an apparatus for refining driving models is provided. The apparatus can include: means for obtaining a machine learning model trained using a set of driving training data; means for processing the set of driving training data to modify a first subset of driving training data from the set of driving training data, the first subset of driving training data associated with a first driving condition; and means for fine-tuning a first instance of the machine learning model using the first modified subset of driving training data.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIGS. 1A and 1B are block diagrams illustrating a vehicle suitable for implementing various techniques described herein, in accordance with aspects of the present disclosure.

FIG. 1C is a block diagram illustrating components of a vehicle suitable for implementing various techniques described herein, in accordance with aspects of the present disclosure.

FIG. 1D illustrates an example implementation of a system-on-a-chip (SOC), in accordance with aspects of the present disclosure.

FIG. 2 is a block diagram of an example transformer, in accordance with aspects of the disclosure.

FIG. 3 is a block diagram example of fine-tuning a machine learning model, in accordance with aspects of the disclosure.

FIG. 4 is a block diagram example of inputs to a machine learning model, in accordance with aspects of the disclosure.

FIG. 5 is a block diagram example of fine-tuning a machine learning model, in accordance with aspects of the disclosure.

FIG. 6 is a block diagram example of motion planning using a machine learning model, in accordance with aspects of the disclosure.

FIG. 7 is a block diagram example of fine tuning a machine learning model, in accordance with aspects of the disclosure.

FIG. 8 is a block diagram example of machine learning model switcher, in accordance with aspects of the disclosure.

FIG. 9 is a flow diagram example of fine-tuning a machine learning model, in accordance with aspects of the disclosure.

FIG. 10 is a block diagram illustrating an example computing-device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As mentioned, autonomous and semi-autonomous vehicles often include multiple sensors to gather information about the environment which processing systems use to perform various functions such as motion planning, collision avoidance, etc. The unpredictability of other vehicles, pedestrians, and obstacles complicates decision-making processes of autonomous vehicles. For example, autonomous vehicles must anticipate the actions taken by other drivers. Further, the manner in which an autonomous vehicle performs an action can affect passenger satisfaction and comfort. For example, decisions made in motion planning (such as rates of acceleration, speed of merging lanes, braking patterns, etc.) can affect passenger confidence in the autonomous vehicle. An action performed by the autonomous vehicle can be safe yet still be undesirable by passengers because the action is not typical of an action performed by a human operator. In such an example, the rate at which an autonomous vehicle merges across lanes, braking patterns, etc. can be safe yet still be undesirable for a passenger.

Many autonomous vehicles can include various machine learning models or systems to determine various driving actions to perform. For example, autonomous vehicles often include a suite of sensors (e.g., radio detection and ranging (RADAR) sensors, light detection and ranging (LIDAR) sensors, cameras, etc.). The autonomous vehicle, or a component thereof, can collect sensor data associated with the environment. For example, the suite of sensors can collect data associated with weather, traffic, obstacles, road conditions, etc.

Processing sensor data and determining actions for an autonomous vehicle to perform is a computationally expensive operation. Quick response times for determining and performing actions is needed in autonomous vehicles to provide a safe experience for passengers and other drivers. Using machine learning models that are fine-tuned for different real-world driving scenarios can reduce computational resources needed for determining actions and can increase response times. Further, fine-tuning a machine learning model based on various driving restrictions for comfort and safety can improve passenger experience with autonomous and semi-autonomous vehicles by providing a safer experience.

Many machine learning models for autonomous vehicles are designed to reproduce behavior inherent in sensor data collected by the autonomous vehicle. There are near limitless examples of scenarios that can occur when operating a vehicle. Training machine learning models to generate motion plans on an appropriately sized dataset poses a problem because datasets often lack sufficient examples for the machine learning model to generate accurate motion plans (e.g., motion plans that are continuous in time and positioning of the vehicle while being safe and comfortable for passengers for all or substantially all driving scenarios). Motion plans can include predictions generated by the machine learning model in response to the sensor data. For example, motion plans can include a trajectory of a vehicle, a waypoint along a route associated with the trajectory of the vehicle, an orientation of the vehicle, a speed of the vehicle, an acceleration of the vehicle, etc. Many autonomous vehicles use mathematical approaches with machine learning models to generate motion plans and refine the motion plans based on reference trajectories (e.g., reference motion plans from training data). Because datasets are more limited in scope in comparison to the possibilities of scenarios that can occur when operating a vehicle, machine learning models for autonomous vehicles often lack accurate reference trajectories (e.g., motion plans from training data) upon which the machine learning model can use to refine motion plans.

Systems, apparatuses, electronic devices, methods (also referred to as processes), and computer-readable media (collectively referred to herein as “systems and techniques”) are described herein for refinement of data driven driving models (e.g., training and fine-tuning machine learning models for autonomous and semi-autonomous vehicles). In some aspects, the systems and devices can include a machine learning model and a motion planner. In some examples, the motion planner is another machine learning model. For example, the machine learning model and the motion planner can use various machine learning model architectures. In some aspects, the machine learning model is a deep learning model such as a neural network (e.g., a convolutional neural network (CNN), a deep neural network (DNN), a recurrent neural network (RNN), a transformer, a large language model (LLM), etc.). The machine learning model can be trained on a set of driving training data. The set of driving training data can include trajectories of the vehicle, a waypoint along a route associated with the trajectory of the vehicle, an orientation of the vehicle, a speed of the vehicle, or an acceleration of the vehicle.

In some aspects the set of driving training data can be a curated dataset (e.g., by a machine learning model, manufacturer of the vehicle, human operator, etc.) associated with real-world scenarios and actions performed by a driver in the real-world scenarios. For example, the set of driving training data can include information associated with the environment in which the driver was operating a vehicle (e.g., traffic conditions, weather conditions, etc.) and actions the driver performed when in the environment (e.g., braking patterns, acceleration speeds, etc.). For example, the driving training data can include data associated with the driver operating the vehicle in a rainstorm. The driving training data can include data associated with how the driver operated the vehicle during the thunderstorm (e.g., changes in braking patterns, changes in speed of the vehicle, etc.). For example, the driving training data can include data associated with how the driver accelerated or decelerated the vehicle during the thunderstorm, driver braking and acceleration patterns when turning during the thunderstorm, distances the driver maintained between the vehicle and other vehicles in traffic, etc.

In some aspects, the driving training data can be associated with events which occurred during driver operation of the vehicle. An event can include actions performed by a driver in response to scenarios captured by the sensor data. For example, the driving training data can be a time series dataset for a predetermined period of operation of the vehicle (e.g., 5 seconds). For example, the set of driving training data can include data associated with 5 second intervals of an event occurring when the vehicle was in operation. For example, the set of driving training data can include a 5 second interval (or other period of time such as 3 seconds, 4 seconds, etc.) before and after an event such as the driver changing lanes when other vehicles are merging onto a highway, the driver braking for a pedestrian, the driver pulling over for an ambulance, etc.

The machine learning model can be trained on the set of driving training data. For example, the machine learning model can be trained using a loss function to compare differences in outputs of the machine learning model to the set of driving training data. Weights of the machine learning model can be adjusted based on the comparison of the outputs of the machine learning model to the set of driving training data. In some examples, the machine learning model can be obtained or received by the systems and techniques as pre-trained using the set of driving training data.

In some aspects, the systems and techniques can set a driving condition of the vehicle. In some aspects, the driving condition can be based on sensor data captured by sensors of the vehicle. For example, the driving condition can be associated with the weather in which the vehicle is operating. In some aspects, the driving condition can be particular to the vehicle. For example, the driving condition can include the make and model of the vehicle. In another example, the driving condition can include the weight of the vehicle, tire pressure of the vehicle, and other information associated with the vehicle. In further examples, a passenger/driver can select a driving condition of the vehicle, such as by setting constraints on operation of the vehicle (e.g., setting a maximum allowed speed, setting an acceleration rate, setting braking patterns, setting a fuel conservation mode, etc.).

In some aspects, the systems and techniques can include processing the set of driving training data to determine a subset of the driving training data associated with the driving condition. For example, the driving condition can include a weather condition, such as rain. The systems and techniques can include determining a subset of the driving training data associated with driving in the rain. In another example, the driving condition can include a make and model of the vehicle. In such an example, the subset of the driving training data can include data associated with operating a vehicle associated with the make and model of the driving condition.

In some aspects, processing the set of driving training data can include modifying the driving training data. For example, processing the set of driving training data can include filtering out driving training data from the set that is not relevant to the driving condition or removing portions of data from the driving training data. For example, when the driving condition includes icy road conditions, processing the set of driving training data can include filtering driving training data for clear weather conditions. In another example, portions of data from the driving training data can be removed, such as portions of data associated with the driver driving on a straight road. For example, the driving training data can include data associated with actions taken by a driver over a thirty second time interval. Processing the set of driving training data can include modifying the data over the thirty second time interval to include a ten second portion of the data associated with an event (e.g., including the data associated with the driver braking when another vehicle merged into a nearby lane, etc.).

In some aspects, the systems and techniques can include fine-tuning the machine learning model using the subset of the driving training data. In some examples, the machine learning model is trained using various supervised or unsupervised training techniques (e.g., Gaussian Mixture Models, neural networks, decision trees, random forest, etc.). For example, the systems and techniques can include adjusting weights of the machine learning model based on the subset of the driving training data. In one example, the systems and techniques can include using a loss function to compare a motion plan generated using the machine learning model to data from the subset of the driving training data. The systems and techniques can adjust weights of the machine learning model based on differences between the motion plan generated by the machine learning model and data from the subset of the driving training data. In some examples, the systems and techniques can include using a loss function to compare a motion plan generated using the machine learning model to a motion plan generated using the motion planner. The motion planner can be associated with one or more driving conditions. In one such example, the motion planner can be associated with a driving condition for driving in snow. The systems and techniques can include using a loss function to compare the motion plan generated using the machine learning model with a motion plan generated using the motion planner. In such an example, the systems and techniques can include fine-tuning weights of the machine learning model based on the comparison.

In some aspects, the systems and techniques can select a vehicle specific motion planner or environment specific motion planner to use to fine tune the machine learning model. In some examples, the systems and techniques can select a motion planner based on the driving condition. In further examples, the systems and techniques can select an additional machine learning model associated with a fine-tuned instance of the machine learning model. For example, when the machine learning model has been fine-tuned based on various driving conditions, the systems and techniques can include selecting a machine learning model associated with the driving conditions encountered by the vehicle (e.g., selecting a machine learning model fine-tuned for driving in snow when sensors of the vehicle detect snow, etc.).

Various aspects of the application will be described with respect to the figures below.

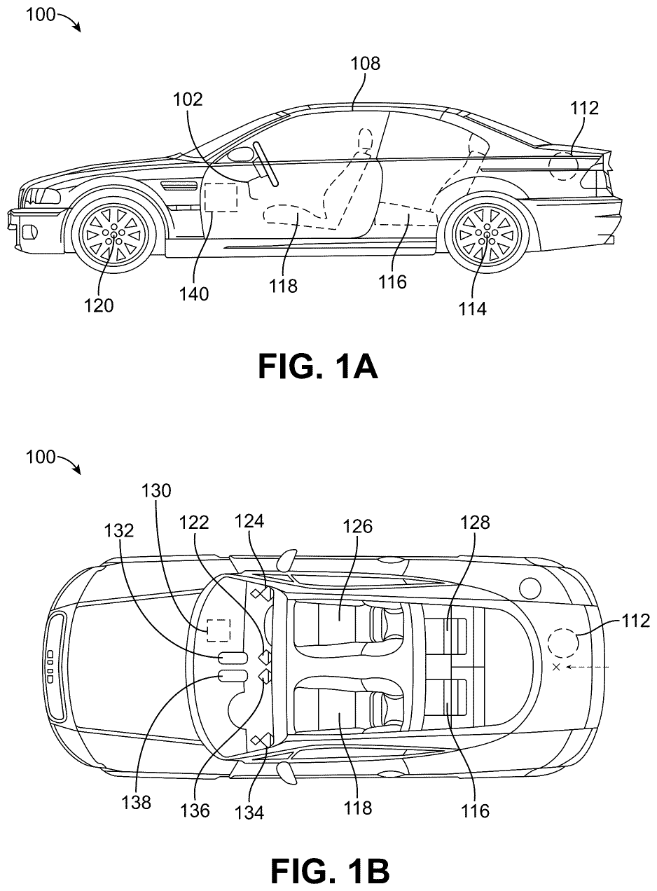

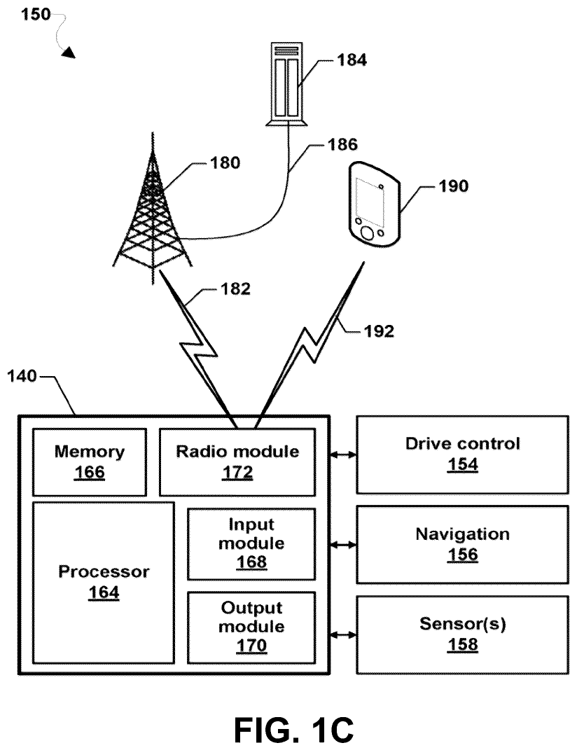

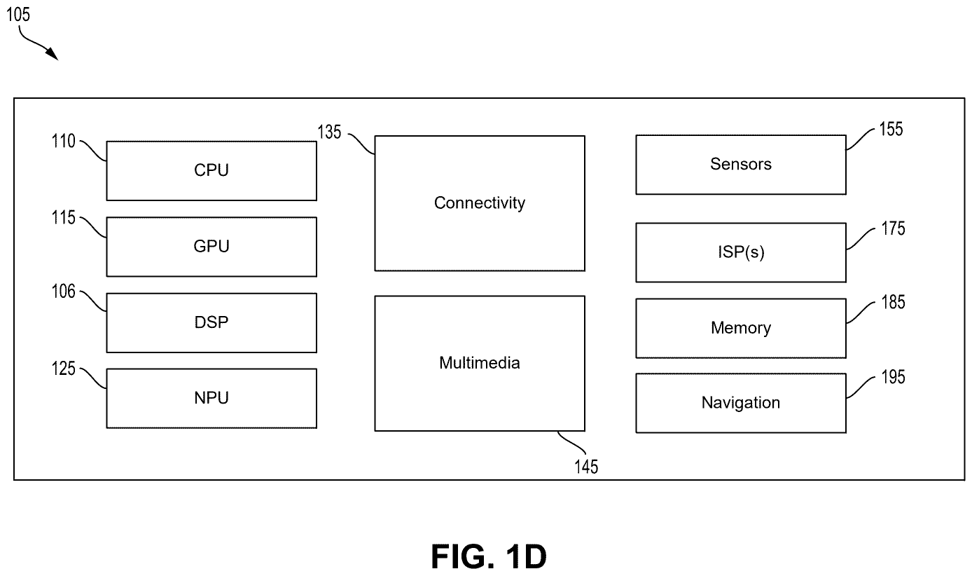

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various embodiments using information received from various sensors, particularly the cameras 122, 136, radar 132, and LIDAR 138. In some embodiments, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various embodiments.

FIG. 1C is a component block diagram illustrating a system 150 of components and support systems suitable for implementing various embodiments. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various embodiments. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some embodiments, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 can be coupled to one or more sensors 158. The sensor(s) 158 can include the sensors 102-138 as described and can be configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

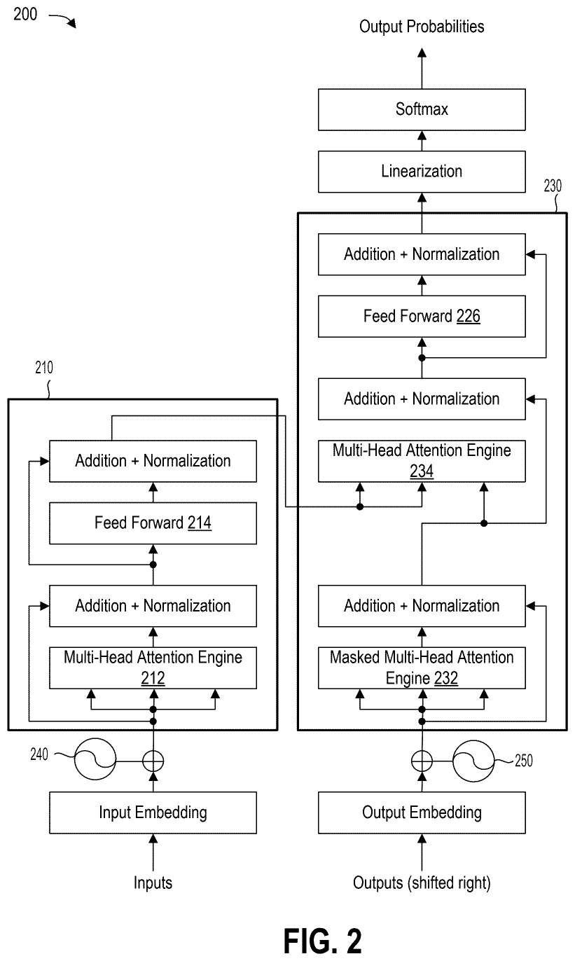

FIG. 2 is a block diagram of an example transformer 200 in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 200 reduces the operations of learning dependencies by using an encoder 210 and a decoder 230 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 210 is composed of a stack of six identical layers and each layer has two sub-layers. The first sub-layer is a multi-head self-attention engine 212, and the second sub-layer is a fully connected feed-forward network 214. A residual connection (not shown) connects around each of the sub-layers followed by normalization.

In this example transformer 200, the decoder 230 is also composed of a stack of six 6 identical layers. The decoder also includes a masked multi-head self-attention engine 232, a multi-head attention engine 234 over the output of the encoder 210, and a fully connected feed-forward network 226. Each layer includes a residual connection (not shown) around the layer, which is followed by layer normalization. The masked multi-head self-attention engine 232 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 240 to encode positions because the model does not contain recurrence and convolution and relative or absolute position of the tokens is needed. In the transformer 200, the positional encodings are added to the input embeddings at the bottom layer of the encoder 210 and the decoder 230. The positional encodings are summed with the embeddings because the positional encodings and embeddings have the same dimensions. A corresponding position decoder 250 is configured to decode the positions of the embeddings for the decoder 230.

In some aspects, the transformer 200 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 200 can process input sequences of variable length, making it well-suited for natural language processing tasks where input lengths can vary greatly. Additionally, the self-attention mechanism allows the transformer 200 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

The transformer architecture of FIG. 2 can be used to generate motion plans for an autonomous or semi-autonomous vehicle. For example, the transformer 200 can process input sequences of sensor data captured by sensors of a vehicle. The transformer 200 can generate a motion plan based on the input sequences of sensor data, such as a trajectory, speed, and acceleration of the vehicle.

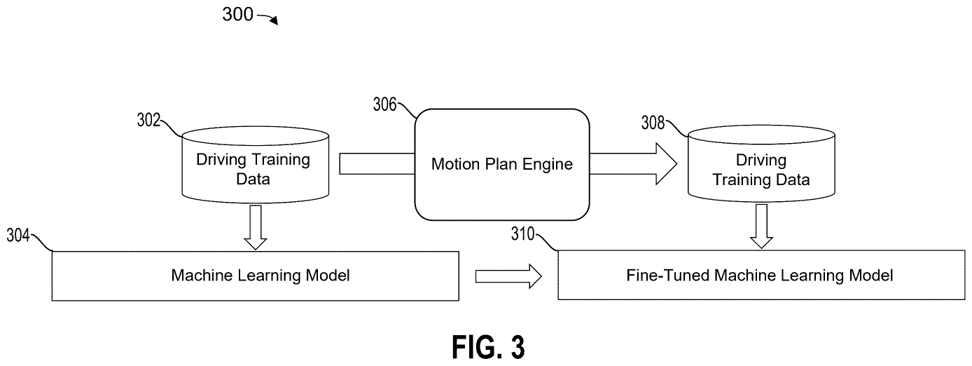

FIG. 3 is a block diagram example 300 of fine-tuning a machine learning model. The block diagram example 300 includes a set of driving training data 302, a machine learning model 304, a motion plan engine 306, a set of motion plans 308, and a fine-tuned machine learning model 310.

The set of driving training data 302 is a set of data associated with real-world driving scenarios. The set of driving training data 302 can be a curated set of data associated with drivers operating a vehicle in the real-world. The set of driving training data 302 can include various data associated with operation of a vehicle. For example, the set of driving training data 302 can include data associated with the vehicle, such as the make, model, and weight of the vehicle. The set of driving training data 302 can further include data associated with the environment in which the driver operated the vehicle. For example, the set of driving training data 302 can include data associated with weather conditions, traffic conditions, road conditions, lane information, etc. The set of driving training data 302 can further include data associated with actions performed by a driver. In another example, the set of driving training data 302 can include data associated with the driver steering, braking, accelerating, switching lanes, merging into traffic, etc.

The machine learning model can be trained using the set of driving training data 302 to generate motion plans for a vehicle. Motion plans can include a predicted trajectory of a vehicle, a waypoint along a route associated with the trajectory of the vehicle, an orientation of the vehicle, a speed of the vehicle, and an acceleration of the vehicle. Training the machine learning model can include using a loss function to compare motion plans generated by the machine learning model to actions performed by a driver from the set of driving training data 302. Training can include adjusting weights of the machine learning model based on the comparison of the set of driving training data 302 and the motion plans generated by the machine learning model 304.

In some examples, the machine learning model is a deep learning model such as a neural network (e.g., a convolutional neural network (CNN), a deep neural network (DNN), a recurrent neural network (RNN), a transformer, a large language model (LLM), etc.). The machine learning model can receive sensor data as input. The machine learning model can generate motion plans based on the sensor data.

The numerical trajectory can receive a subset of the driving training data associated with various driving conditions associated with the motion plan engine 306. For example, the motion plan engine can be associated with a particular make, model, and weight of vehicle. In further examples, the motion plan engine can receive a set of driving conditions from a driver or the vehicle. In some examples, the motion plan engine can determine driving conditions based sensor data of the vehicle. For example, the motion plan engine 306 can determine the make and model of the vehicle from the vehicle, a maximum acceleration speed from the user, and weather conditions for operating the vehicle from the sensor data. The motion plan engine can generate a set of motion plans 308 associated with driving conditions. The motion plans 308 can be the driving training data 302 with or a subset of the driving training data. In some examples, the motion plan engine 306 is an algorithm such as a model predictive control algorithm to modify the driving training data 302 for an objective (e.g., based on a driving condition). For example, the motion plan engine 306 can modify the driving training data 302 based on comfort of a user, desired driving behavior (e.g., cautious driving, more aggressive driving, etc.), weather conditions, etc. In another example, the motion plan engine 306 can modify the driving training data 302 based on a make, model, or weight of vehicle. For example, driving training data for braking with a sedan can be modified for braking with a heavier vehicle such as a truck.

In some examples, the motion plan engine 306 can process the set of driving training data 302 to generate a subset of driving training data of the set of driving training data. In some examples, the motion plan engine can be a machine learning model. The motion plan engine can process the set of driving training data to determine a subset of the driving training data associated with a driving condition. For example, the driving condition can include a weather condition, such as snow. The motion plan engine 306 can process the set of driving training data to determine a subset of the driving training data associated with driving in the snow. The motion plan engine 306 can generate the set of motion plans 308 based on the subset of the driving training data.

In some examples, processing the set of driving training data can include modifying the driving training data from the set. For example, processing the set of driving training data can include filtering driving training data from the set unrelated to the driving condition. For example, the driving condition can be associated with a semi-truck weighing over 20000 pounds. The motion plan engine 306 can modify driving training data by removing portions of the data from driving training data. For example, the driving training data can include data associated with actions taken by a driver over a 10 second period of time. Processing the set of driving training data can include removing portions of the driving training data to include a 5 second period of time associated with an event (e.g., including the data associated with the driver accelerating, merging, braking, etc.).

The machine learning model 304 can be fine-tuned based on the set of motion plans 308 to provide fine-tuned machine learning model 310. In some examples, the machine learning model 304 can be fine-tuned based on the subset of driving training data or the motion plans 308 generated by the motion plan engine 306. In some examples, the machine learning model 304 can be fine-tuned using a loss function to compare motion plans of generated by the machine learning model 304 to the motion plans generated by the motion plan engine 306. Fine-tuning the machine learning model 304 can include using a loss function to compare the motion plan generated using the machine learning model with a motion plan generated using the motion plan engine 306. In such an example, the systems and techniques can include fine-tuning weights of the machine learning model based on the comparison.

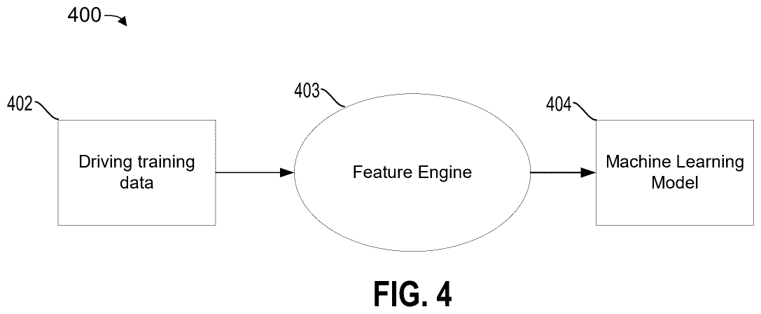

FIG. 4 is an example block diagram 400 of inputs to a machine learning model 404. For example, the machine learning model 404 can receive driving training data 402 as inputs. The driving training data 402 can include data such as trajectory data (e.g., position, pose, time, etc.) of a vehicle operated by a driver. The driving training data 402 can further include sensor data associated with the environment in which a vehicle was operated. For example, the sensor data can include data such as objects detected by a vehicle, traffic, weather, and routes taken by a vehicle. In some examples, the driving training data 402 can be provided to a feature engine 403 to process the driving training data 402. For example, the feature engine 403 can process the driving training data 402 to transform the driving training data 402 to an embedding space representation of the driving training data to be received by the machine learning model 404. In some examples, the feature engine 403 is part of the machine learning model 404.

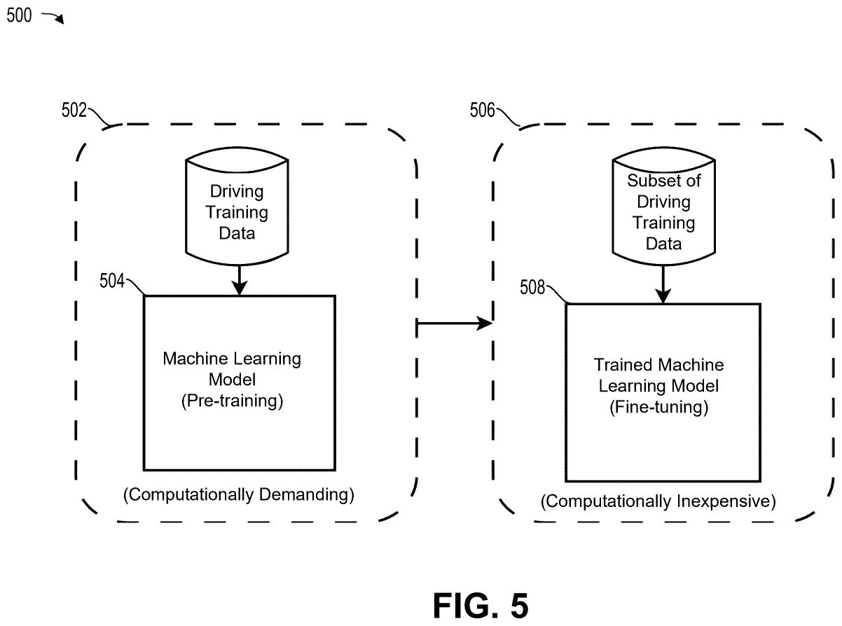

FIG. 5 is an example block diagram 500 of fine-tuning and training a machine learning model. FIG. 5 includes a training step 502 and a fine-tuning step 506. In the training step 502, the machine learning model 504 is trained using a set of driving training data (e.g., the driving training data described in the description of FIG. 3 and FIG. 4). In some examples, the driving training data is an unlabeled dataset. In the fine-tuning step 506, the machine learning model 504 that was trained in the training step 502 (represented as trained machine learning model 508) can be fine tuned based on a subset of driving training data from the set of driving training data. In some examples, the subset of driving training data can include data not within the set of driving training data. For example, the trained machine learning model 508 can be fine-tuned using a labeled dataset separate from the set of driving training data.

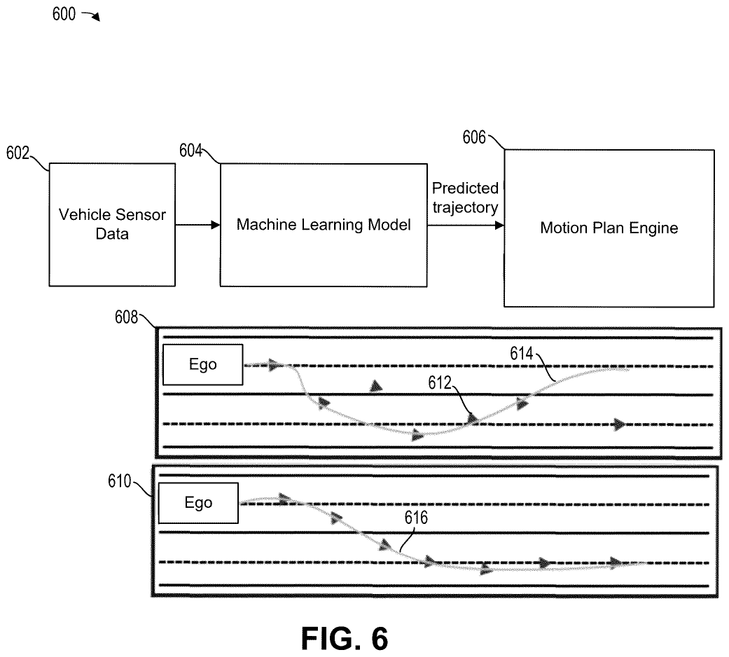

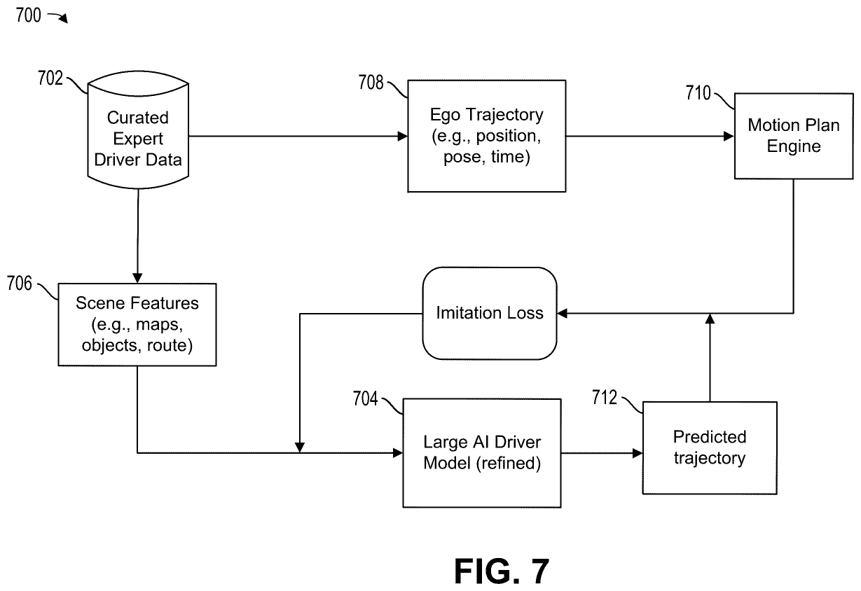

FIG. 6 is an example block diagram 600 of motion planning using a machine learning model. For example, the block diagram 600 include vehicle sensor data 602, a machine learning model 604, and a motion plan engine 606. The machine learning model 604 can be a pretrained model (e.g., the trained machine learning model 508 of FIG. 5), trained on a set of driving training data. The machine learning model 604 can generate a motion plan based on the vehicle sensor data, such as motion plan 608. In some examples, the vehicle sensor data can include received information such as map data and traffic data in addition to the sensor data captured by sensors of the vehicle. The motion plan engine 606 can be used to fine-tune the machine learning model 604, as further described in the description of FIG. 3 and FIG. 7.

Motion plans can include predictions generated by the machine learning model 604 in response to the vehicle sensor data 602. For example, the motion plans can include a trajectory of a vehicle, a waypoint along a route associated with the trajectory of the vehicle, an orientation of the vehicle, a speed of the vehicle, an acceleration of the vehicle, etc. Motion plan 608 represents an example motion plan generated by a machine learning model that has not been fine-tuned. Motion plan 610 represents a motion plan generated by a machine learning model that has been fine-tuned. Motion plan 608 includes a first trajectory 614 representing the movement of the vehicle predicted by the machine learning model (e.g., the machine learning model that has not been fine-tuned). The first trajectory is based on reference trajectory waypoints 612 which represent a predicted location of the vehicle at a predicted time, a predicted orientation of the vehicle, a predicted speed of the vehicle, predicted acceleration of the vehicle, predicted jerk of the vehicle, etc. Motion plan 610 includes a second trajectory 616 representing the movement of the vehicle predicted by the fine-tuned machine learning model.

FIG. 7 is a block diagram 700 representing fine-tuning of a machine learning model 704. By way of example, the machine learning model 704 is pre-trained on a set of driving training data. The machine learning model can be fine-tuned using a set of curated driving training data 702. For example, the set of curated driving training data 702 can be a subset of the set of driving training data. In some examples, an additional machine learning model can process the set of driving training data to determine a subset of driving training data from the set associated with a driving condition. For example, the machine learning model 704 can be fine-tuned to drive during icy road conditions using driving training data from the set of driving training data associated with icy road conditions. In further examples, the set of curated driving training data 702 is a separate set of data (e.g., not a subset of a set of driving training data used to train the machine learning model), such as a separate labeled dataset associated with the driving condition.

The set of curated driving training data 702 can include data associated with the environment in which a vehicle was operated, and actions taken by a driver. For example, the set of curated driving training data 702 can include environmental data 706 such as map data, traffic conditions, weather conditions, road conditions, route information, object detection results (e.g., detected objects), etc. The set of curated driving training data 702 can further include driver action data 708 associated with actions performed by the driver (e.g., actions performed by the driver when operating the vehicle during environmental conditions represented by the environmental data 706). The driver action data 708 can include data associated with vehicle trajectories, acceleration, braking, etc.

A motion plan engine 710 can receive the driver action data 708 associated with the actions performed by the driver and modify the driver action data 708. For example, the motion plan engine 710 can filter the driver action data 708 to only include driver action data 708 associated with one or more driving conditions. For example, the motion plan engine 710 can include driving conditions such as vehicle operation during rainy weather conditions, vehicle operation for a vehicle towing a trailer, vehicle operation for a sedan less than 4000 pounds, etc. The motion plan engine 710 can use the modified driver action data to fine tune the machine learning model 704. For example, the machine learning model 704 can receive the environmental data and generate a motion plan 712 (e.g., predicted trajectories of a vehicle, predicted speed, predicted acceleration, etc.) associated with the environmental data. The output motion plan of the machine learning model 704 can be compared to the modified driver action data generated by the motion plan engine 710. Weights of the machine learning model 704 can be adjusted based on the differences between the motion plan of the machine learning model 704 and the modified driver action data.

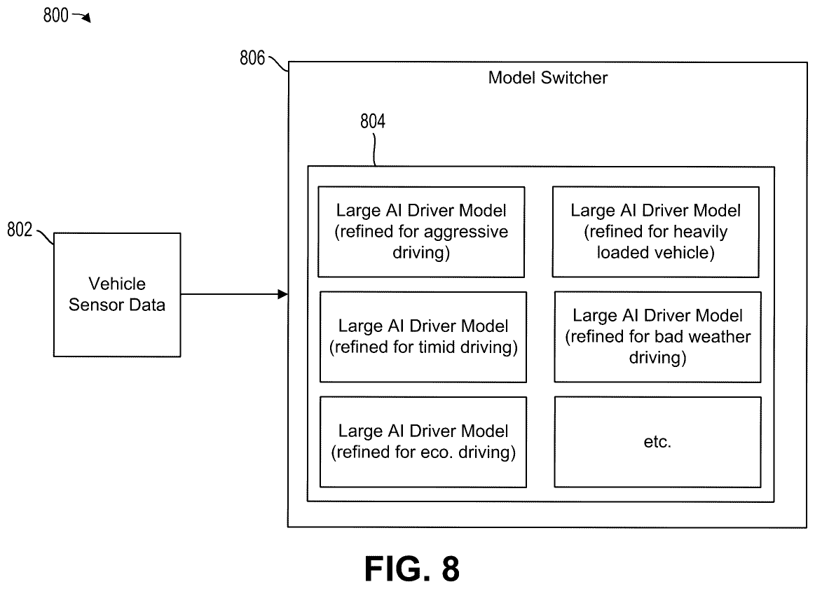

FIG. 8 is a block diagram 800 illustrating an example model switcher 806 for switching between fine-tuned machine learning models. For example, machine learning models fine-tuned using the systems and techniques of FIGS. 3-7 can be stored in memory (e.g., locally in memory on a device associated with the vehicle or in a database accessible by a device associated with the vehicle). The vehicle, or a component thereof, can select a fine-tuned machine learning model 804 to use to generate motion plans. For example, the model switcher can include various fine-tuned machine learning models for the vehicle to use for generating motion plans, such as a fine-tuned machine learning model for heavy traffic, for wet road conditions, for icy road conditions, for vehicles exceeding 20000 pounds, for different jurisdictions (e.g., different countries and cities), etc.

In some examples, a vehicle (or component thereof) can select a fine-tuned machine learning model based on vehicle sensor data 802. For example, the vehicle (or component thereof) can detect wet road conditions and select the fine-tuned machine learning model 804 associated with wet road conditions. The vehicle can use the selected machine learning model to generate motion plans for the vehicle.

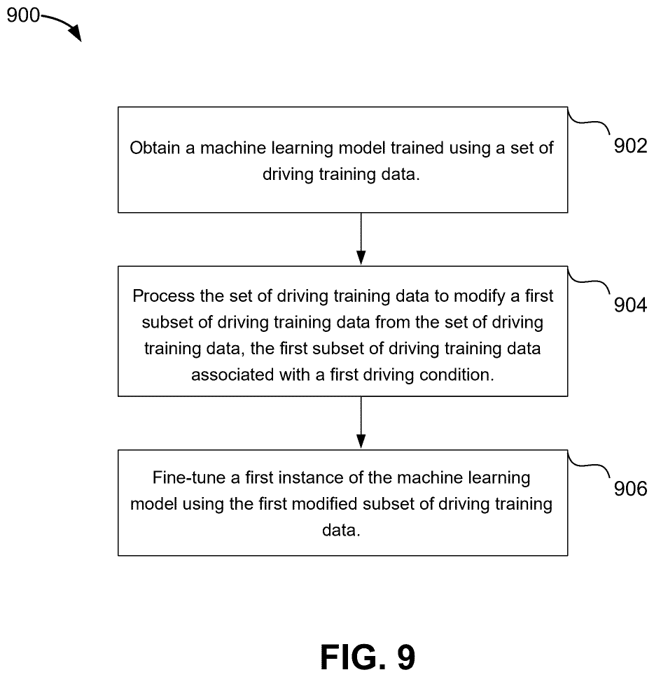

FIG. 9 is a flow diagram illustrating an example process 900 for refining driving models (e.g., fine-tuning machine learning models) in accordance with aspects of the present disclosure. One or more operations of process 900 can be performed by a computing device (or apparatus) or a component (e.g., a chipset, codec, etc.) of the computing device. The computing device can be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, and/or any other computing device with the resource capabilities to perform the process 900. The one or more operations of process 900 can be implemented as software components that are executed and run on one or more processors.

At block 902, the computing device (or component thereof) can obtain a machine learning model trained using a set of driving training data. The machine learning model can be pre-trained model based on the driving training data. For example, the driving training data can include the driving training data 302 of FIG. 3, the driving training data 402 of FIG. 4, the set of curated driving training data 702 of FIG. 7, or the driving training data of FIG. 5. The driving training data can be used to train the machine learning model, such as the machine learning model 304, 404, 504, 604, 704 of FIGS. 3-7, for autonomous or semi-autonomous driving. In some examples, the machine learning model is a trajectory generation model. In some examples, the machine learning model can be based on transformer architecture, such as the transformer 200 of FIG. 2. In some examples, the driving training data includes a dataset of real-world driving scenarios and actions performed by a driver in the real-world driving scenarios. In some examples, the machine learning model can be trained using on-device training (e.g., trained using the computing device or component thereof) or can be received pre-trained from another device.

At block 904, the computing device (or component thereof) can process the set of driving training data to modify a first subset of driving training data from the set of driving training data. The first subset of driving training data can be associated with a first driving condition. For example, the first subset of driving training data can be the subset of driving training data of FIG. 5 or the motion plans 308 of FIG. 3. For example, the computing device can process the set of driving training data to remove data from the set of driving training data determined to be not relevant to fine-tuning the machine learning model. In some examples, the computing device can process the driving training data to remove data based on a driving condition, such as a condition associated with weather, associated with the driver, associated with the vehicle, etc. For example, driving training data associated with driving a sedan on a straight road in clear weather conditions can be removed from the set of training based on a driving condition associated with driving a truck during rain. In another example, the process the modified first subset of driving training data can include a selection of driving training data associated with the first driving condition from the set of driving training data. For example, the driving conditions (such as the first driving condition) can include at least one of a weight of a vehicle, a model of the vehicle, or weather. The computing device (or component thereof) can modify the first subset of driving training data and store the first modified subset of driving training data in a data base, repository, etc. which can be accessed to fine-tune the machine learning model.

At block 906, the computing device (or component thereof) can fine-tune a first instance of the machine learning model (e.g., the trained machine learning model of block 902) using the first modified subset of driving training data. For example, the first instance of the machine learning model can be fine-tuned using a loss function to compare differences between a first motion plan generated using the first instance of the machine learning model and a second motion plan associated with the first driving condition. Various fine-tuning processes and loss functions can be used, such as mean squared error (MSE) loss functions, to fine-tune the first instance of the machine learning model.

The fine-tuned machine learning model can be used to generate a motion plan associated with a driving condition (e.g., the first driving condition). The motion plan can include at least one of a trajectory of a vehicle, a waypoint along a route associated with the trajectory of the vehicle, an orientation of the vehicle, a speed of the vehicle, or an acceleration of the vehicle.

In some examples, the computing device (or component thereof) can process the set of driving training data to modify a second subset of driving training data from the second set of driving training data. In such an example, the second subset of driving training data can be associated with a second driving condition such as a driving condition different from the first driving condition. The computing device (or component thereof) can fine-tune a second instance of the machine learning model (e.g., the machine learning model of block 902) using the second subset of driving training data. In some examples, the fine-tuned instances of the machine learning model (e.g., the first instance and the second instance) can be stored in a repository or database and can be selected for use when a vehicle detects a driving condition associated with one or more of the fine-tuned instances of the machine learning model. For example, a first fine-tuned instance of the machine learning model can be associated with a truck operating on icy road conditions. The computing device (or component thereof) can select the first fine-tuned instance of the machine learning to generate the motion plan based on the first driving condition. In some examples, the computing device (or component thereof) can select, based on sensor data of a vehicle, an instance of the machine learning model. For example, the vehicle can include sensors such as cameras to detect weather conditions, such as the presence of rain. In such an example, the computing device (or component thereof) can determine to generate motion plans using a fine-tuned instance of the machine learning model associated with driving in the rain.

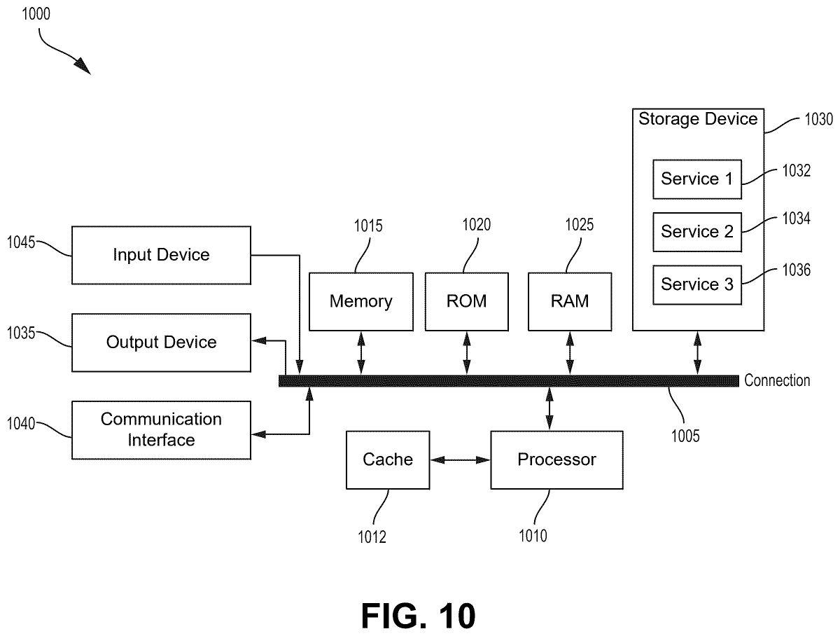

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1000 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 1000 also includes a connection 1005 that couples various system components including system memory 1015, such as read-only memory (ROM) 1020 and random-access memory (RAM) 1025 to processor 1010. Computing system 1000 can include a cache 1012 of high-speed memory connected directly with, in close proximity to, or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 can essentially be a completely self-contained computing system, containing multiple cores or processors, a bus, memory controller, cache, etc. A multi-core processor can be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 can also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc. When the code that defines such software is executed by the processor 1010, the code causes the system to perform a function. In some aspects, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:

Aspect 1: An apparatus for refining driving models, the apparatus comprising: at least one memory; and at least one processor coupled to the at least one memory and configured to: obtain a machine learning model trained using a set of driving training data; process the set of driving training data to modify a first subset of driving training data from the set of driving training data, the first subset of driving training data associated with a first driving condition; and fine-tune a first instance of the machine learning model using the first modified subset of driving training data.

Aspect 2: The apparatus of Aspect 1, wherein the at least one processor is configured to: generate a motion plan using the fine-tuned first instance of the machine learning model.

Aspect 3: The apparatus of any of Aspects 1 to 2, wherein the motion plan includes at least one of a trajectory of a vehicle, a waypoint along a route associated with the trajectory of the vehicle, an orientation of the vehicle, a speed of the vehicle, or an acceleration of the vehicle.

Aspect 4: The apparatus of any of Aspects 1 to 3, wherein the at least one processor is configured to: process the set of driving training data to modify a second subset of driving training data from the set of driving training data, the second subset of driving training data associated with a second driving condition; and fine-tune a second instance of the machine learning model using the second modified subset of driving training data.

Aspect 5: The apparatus of Aspect 4, wherein the at least one processor is configured to: select, based on sensor data of a vehicle, an instance of the machine learning model; and generate a motion plan using the selected instance of the machine learning model.

Aspect 6: The apparatus of Aspect 4, wherein the first driving condition and the second driving condition includes at least one of a weight of a vehicle, a model of the vehicle, or weather.

Aspect 7: The apparatus of any of Aspects 1 to 6, wherein the machine learning model is a trajectory generation model.

Aspect 8: The apparatus of any of Aspects 1 to 7, wherein the set of driving training data includes a dataset of real-world driving scenarios and actions performed by a driver in the real-world driving scenarios.

Aspect 9: The apparatus of any of Aspects 1 to 8, wherein the at least one processor is configured to: process the set of driving training data to modify the first subset of driving training data from the set of driving training data, wherein the modified first subset of driving training data includes a selection of driving training data associated with the first driving condition from the set of driving training data.

Aspect 10: The apparatus of any of Aspects 1 to 9, wherein the first instance of the machine learning model is fine-tuned using a loss function to compare differences between a first motion plan generated using the first instance of the machine learning model and a second motion plan associated with the first driving condition.

Aspect 11: The apparatus of any of Aspects 1 to 10, wherein the machine learning model is trained using on-device training.

Aspect 12: A method for refining driving models, the method comprising: obtaining a machine learning model trained using a set of driving training data; processing the set of driving training data to modify a first subset of driving training data from the set of driving training data, the first subset of driving training data associated with a first driving condition; and fine-tuning a first instance of the machine learning model using the first modified subset of driving training data.

Aspect 13: The method of Aspect 12, further comprising: generating a motion plan using the fine-tuned first instance of the machine learning model.

Aspect 14: The method of any of Aspects 12 to 13, wherein the motion plan includes at least one of a trajectory of a vehicle, a waypoint along a route associated with the trajectory of the vehicle, an orientation of the vehicle, a speed of the vehicle, or an acceleration of the vehicle.

Aspect 15: The method of any of Aspects 12 to 14, further comprising: processing the set of driving training data to modify a second subset of driving training data from the set of driving training data, the second subset of driving training data associated with a second driving condition; and fine-tuning a second instance of the machine learning model using the second modified subset of driving training data.

Aspect 16: The method of any of Aspects 12 to 15, further comprising: selecting, based on sensor data of a vehicle, an instance of the machine learning model; and generating a motion plan using the selected instance of the machine learning model.

Aspect 17: The method of Aspect 15, wherein the first driving condition and the second driving condition includes at least one of a weight of a vehicle, a model of the vehicle, or weather.

Aspect 18: The method of any of Aspects 12 to 17, wherein the machine learning model is a trajectory generation model.

Aspect 19: The method of any of Aspects 12 to 18, wherein the set of driving training data includes a dataset of real-world driving scenarios and actions performed by a driver in the real-world driving scenarios.

Aspect 20: The method of any of Aspects 12 to 19, further comprising: processing the set of driving training data to modify the first subset of driving training data from the set of driving training data, wherein the modified first subset of driving training data includes a selection of driving training data associated with the first driving condition from the set of driving training data.

Aspect 21: The method of any of Aspects 12 to 20, wherein the first instance of the machine learning model is fine-tuned using a loss function to compare differences between a first motion plan generated using the first instance of the machine learning model and a second motion plan associated with the first driving condition.

Aspect 22: The method of any of Aspects 12 to 21, wherein the machine learning model is trained using on-device training.

Aspect 23: An apparatus for refining driving models is provided. The apparatus includes one or more means for performing operations according to any of Aspects 12 to 22.

Aspect 24: A non-transitory computer-readable medium is provided having stored thereon instructions that, when executed by at least one processor, cause the at least one processor to perform operations according to any of Aspects 12 to 22.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for refining driving models, the apparatus comprising:
at least one memory; and
at least one processor coupled to the at least one memory and configured to:
obtain a machine learning model trained using a set of driving training data;
process the set of driving training data to modify a first subset of driving training data from the set of driving training data, the first subset of driving training data associated with a first driving condition; and
fine-tune a first instance of the machine learning model using the first modified subset of driving training data.

2. The apparatus of claim 1, wherein the at least one processor is configured to:
generate a motion plan using the fine-tuned first instance of the machine learning model.

3. The apparatus of claim 2, wherein the motion plan includes at least one of a trajectory of a vehicle, a waypoint along a route associated with the trajectory of the vehicle, an orientation of the vehicle, a speed of the vehicle, or an acceleration of the vehicle.

4. The apparatus of claim 1, wherein the at least one processor is configured to:
process the set of driving training data to modify a second subset of driving training data from the set of driving training data, the second subset of driving training data associated with a second driving condition; and
fine-tune a second instance of the machine learning model using the second modified subset of driving training data.

5. The apparatus of claim 4, wherein the at least one processor is configured to:
select, based on sensor data of a vehicle, an instance of the machine learning model; and
generate a motion plan using the selected instance of the machine learning model.

6. The apparatus of claim 4, wherein the first driving condition and the second driving condition includes at least one of a weight of a vehicle, a model of the vehicle, or weather.

7. The apparatus of claim 1, wherein the machine learning model is a trajectory generation model.

8. The apparatus of claim 1, wherein the set of driving training data includes a dataset of real-world driving scenarios and actions performed by a driver in the real-world driving scenarios.

9. The apparatus of claim 1, wherein the at least one processor is configured to:
process the set of driving training data to modify the first subset of driving training data from the set of driving training data, wherein the modified first subset of driving training data includes a selection of driving training data associated with the first driving condition from the set of driving training data.

10. The apparatus of claim 1, wherein the first instance of the machine learning model is fine-tuned using a loss function to compare differences between a first motion plan generated using the first instance of the machine learning model and a second motion plan associated with the first driving condition.

11. The apparatus of claim 1, wherein the machine learning model is trained using on-device training.

12. A method for refining driving models, the method comprising:
obtaining a machine learning model trained using a set of driving training data;
processing the set of driving training data to modify a first subset of driving training data from the set of driving training data, the first subset of driving training data associated with a first driving condition; and
fine-tuning a first instance of the machine learning model using the first modified subset of driving training data.

13. The method of claim 12, further comprising:
generating a motion plan using the fine-tuned first instance of the machine learning model.

14. The method of claim 13, wherein the motion plan includes at least one of a trajectory of a vehicle, a waypoint along a route associated with the trajectory of the vehicle, an orientation of the vehicle, a speed of the vehicle, or an acceleration of the vehicle.

15. The method of claim 12, further comprising:
processing the set of driving training data to modify a second subset of driving training data from the set of driving training data, the second subset of driving training data associated with a second driving condition; and
fine-tuning a second instance of the machine learning model using the second modified subset of driving training data.

16. The method of claim 15, further comprising:
selecting, based on sensor data of a vehicle, an instance of the machine learning model; and
generating a motion plan using the selected instance of the machine learning model.

17. The method of claim 15, wherein the first driving condition and the second driving condition includes at least one of a weight of a vehicle, a model of the vehicle, or weather.

18. The method of claim 12, wherein the machine learning model is a trajectory generation model.

19. The method of claim 12, wherein the set of driving training data includes a dataset of real-world driving scenarios and actions performed by a driver in the real-world driving scenarios.

20. The method of claim 12, further comprising:
processing the set of driving training data to modify the first subset of driving training data from the set of driving training data, wherein the modified first subset of driving training data includes a selection of driving training data associated with the first driving condition from the set of driving training data.
